(19) United States
(12) Patent Application Publication
(10) Pub. No.: US 2026/0167066 A1
(43) Pub. Date: Jun. 18, 2026

(54) LOCKING DEVICE FOR A VEHICLE WALK-IN SEAT

(71) Applicants: HYUNDAI MOTOR COMPANY, Seoul (KR); KIA CORPORATION, Seoul (KR); DAS CO., LTD, Gyeongju-si (KR)

(72) Inventors: Ho Suk Jung, Hwaseong-si (KR); Ju Yeol Kong, Hwaseong-si (KR); Hyeok Seung Lee, Hwaseong-si (KR); Han Kyeol Cho, Hwaseong-si (KR); Chan Ho Jung, Hwaseong-si (KR); Sung Wook Lee, Bucheon-si (KR); Dong Man Lee, Suwon-si (KR); Jong Beom Na, Hwaseong-si (KR); Jung Ho Yoo, Suwon-si (KR); Ji Yun Jang, Suwon-si (KR)

(73) Assignees: HYUNDAI MOTOR COMPANY, Seoul (KR); KIA CORPORATION, Seoul (KR); DAS CO., LTD, Gyeongju-si (KR)

(21) Appl. No.: 19/213,676

(22) Filed: May 20, 2025

(30) Foreign Application Priority Data
Dec. 12, 2024 (KR) 10-2024-0184781

(51) Int. Cl. B60N 2/12; B60N 2/02

(52) U.S. Cl. CPC B60N 2/12; B60N 2/02253

(57) ABSTRACT

A locking device for a vehicle walk-in seat includes: a seat cushion part mounted on a movement rail of a seat rail and configured to slidably move along the seat rail, a rear link having a side mounted on a rear portion of the seat cushion part and another side mounted on a rear side of the movement rail, a front link having a side mounted on a front portion of the seat cushion part and another side mounted on a front side of the movement rail of the seat rail, a locking part locked with the rear link or the front link, and a switching guide part mounted on a lower portion of the seat cushion part and configured to move in a state of being seated on a slide guide provided on a fixed rail of the seat rail.

### CROSS-REFERENCE TO RELATED APPLICATION

This application claims, under 35 U.S.C. § 119(a), the benefit of and priority to Korean Patent Application No. 10-2024-0184781, filed on Dec. 12, 2024, the entire contents of which are incorporated herein by reference.

### BACKGROUND

### (a) Technical Field

The present disclosure relates to a locking device for a vehicle walk-in seat to perform a walk-in tilting function.

### (b) Background Art

In general, seats installed in the interior of a passenger vehicle include first-row seats (e.g., front seats) and second-row seats (e.g., rear seats). In a van and a sport utility vehicle, at least a third row of seats is provided in addition to the first-row seats and the second-row seats. The seats may be installed in various arrangements.

Various mechanisms are applied to these vehicle seats. For example, the mechanisms may provide comfortable seating to a passenger, may provide convenience when a passenger enters and exits the vehicle, and may provide convenience in expanding space of a luggage compartment.

As an example, when at least a third row of seats is installed in the vehicle, passengers may access the first-row seats and second-row seats by opening the front door and the rear door, respectively. Here, the seat in the third row is configured to allow access for passengers entering or exiting the vehicle by utilizing a walk-in function associated with the second-row seats.

For example, in order to create space for a passenger seated in the third-row seat to enter or exit the vehicle, the walk-in mechanism of the second-row seat enables the seatback of the second-row seat to recline forward, followed by the seat cushion sliding forward.

As another example, in the case of the seat in the second row, in order to implement a comfortable seating posture of a passenger, a titling function is performed to move the front portion of the seat cushion upwards, and the seatback is reclined rearwards, thereby implementing a relaxation mode of the seat.

However, in the above-described seat structural configuration, since a locking structure configured to stably fix the position of the seat cushion is provided on one side of the seat, deformation may occur in the other side of the seat to which the locking structure is not applied, leading to deterioration in quality of the seat.

The above information disclosed in this Background section is only for enhancement of understanding of the background of the disclosure, and therefore it may contain information that does not form the prior art that is already known to a person of ordinary skill in the art.

### SUMMARY

The present disclosure provides a locking device for a vehicle walk-in seat, which applies a locking system to lock the seat in a set seating section and selectively release locking of the seat when the seat moves from the set seating section to a set non-seating section, i.e., when the seat is slidably moved forward. By utilizing the sliding movement of the seat to transition between locked and unlocked states, the system enables a walk-in tilting mode.

In one aspect of the present disclosure, a locking device for a vehicle walk-in seat includes: a seat cushion part mounted on a movement rail of a seat rail and configured to slide along the seat rail; a rear link; and a front link. The rear link includes one side (i.e., a first part) mounted on a rear portion of the seat cushion part, and the other side (i.e., a second part) mounted on a rear portion of the movement rail of the seat rail. T front link includes one side (a first part) mounted on a front portion of the seat cushion part, and the other side (i.e., a second part) mounted on a front part of the movement rail of the seat rail. The locking device further includes: a locking part configured to engage or lock with the rear link or the front link; and a switching guide part mounted on the seat cushion part and configured to be seated on a slide guide provided in a fixed rail of the seat rail and move such that the locking part is released from engagement with the rear link or the front link.

In an embodiment, the rear link may include: a first link mounted on a first side of the rear portion of the seat cushion part, and a second link mounted on a second side of the rear portion of the seat cushion part. The front link may include a third link mounted on a first side of the front portion of the seat cushion part, and a fourth link mounted on a second side of the front portion of the seat cushion part. In particular, the locking part is configured to engage with at least one of the first link, the second link, the third link, or the fourth link.

In another embodiment, the locking device may further include a driving part mounted on one side of the rear portion of the seat cushion part and coupled to the first link. The driving part is configured to apply a driving force to the first link to rotate the seat cushion part forward or rearward.

In still another embodiment, the locking part may further include: a first locking part mounted on the other side of the rear portion of the seat cushion part and configured to engage with the second link facing the first link; and a second locking part mounted on one side of the front portion of the seat cushion part and configured to engage with the third link located in front of the first link.

In yet another embodiment, the first locking part may include: a mounting plate fixedly mounted on the other side of the rear portion of the seat cushion part; a release lever rotatably coupled to the mounting plate and connected to the switching guide part; a cam member configured to rotate with the release lever; a locking plate including a protruding member configured to engage the cam member, the locking plate being rotated in conjunction with rotation of the cam member and configured to selectively or disengage or unlocked from the rear link; and an elastic member mounted on the mounting plate and connected to the release lever, the elastic member configured to provide an elastic restoring force to the release lever.

In still yet another embodiment, the locking plate may have a locking guide member formed to extend in a longitudinal direction and configured to be locked with a locking piece of the rear link. The locking plate is configured to rotate in a direction opposite to a rotation direction of the cam member so as to be disengaged or unlocked from the locking piece.

In a further embodiment, the second locking part may include a mounting plate fixedly mounted on one side of the front portion of the seat cushion part, and a locking bracket connected to the switching guide part and configured to be rotatably coupled to the mounting plate.

In another further embodiment, the locking bracket may include a locking pin mounted in the mounting plate and formed to have a shape corresponding to a shape of a locking groove formed in the front link, and the locking pin may be disengaged or unlocked from the locking groove when the locking bracket is rotated rearward on the mounting plate by the switching guide part.

In still another further embodiment, the second locking part may further include an elastic member mounted on the mounting plate and connected to the locking bracket. The elastic member is configured to provide an elastic restoring force to the locking bracket.

In yet another further embodiment, when the locking part is disengaged (e.g., unlocked), the seat cushion part may be rotatably tilted in conjunction with driving of the driving part.

In still yet another further embodiment, the switching guide part may include: a mounting plate fixedly mounted on the lower portion of the seat cushion part; an unlocking lever configured to rotate on the mounting plate when the slide guide contacts the unlocking lever connected to the locking part; a roller member coupled to the unlocking lever and configured to guide the unlocking lever to move along the slide guide; and an elastic member mounted on the mounting plate and connected to the unlocking lever, the elastic member being configured to apply an elastic restoring force to the unlocking lever.

In a still further embodiment, the rear link may include a first link mounted on one side of the rear portion of the seat cushion part, and a second link mounted on the other side of the rear portion of the seat cushion part. The front link may include a third link mounted on one side of the front portion of the seat cushion part, and a fourth link mounted on the other side of the front portion of the seat cushion part. In an embodiment, the locking part may include: a first locking part mounted on the other side of the rear portion of the seat cushion part and configured to engage with the second link facing the first link, and a second locking part mounted on one side of the front portion of the seat cushion part and configured to engage with the third link located in front of the first link. In particular, the unlocking lever may include a first cable connected to the first locking part and a second cable connected to the second locking part.

In a yet still further embodiment, the unlocking lever may simultaneously move the first cable and the second cable by rotation thereof on the mounting plate, thereby allowing the first locking part and the second locking part to be respectively unlocked from the rear link and the front link.

In another embodiment, the slide guide may include a side inclined upward so as to allow the switching guide part to be rotatably moved.

In still another embodiment, the slide guide may be provided at a position allowing the slide guide to contact the switching guide part in a non-seating section set on a slide movement path of the seat cushion part.

In yet another embodiment, the locking device may further include a controller configured to, in response to receiving a walk-in tilting control command, move the seat cushion part t forward and move the switching guide part along the slide guide to initiate a walk-in tilting mode.

In still yet another embodiment, the walk-in tilting mode may be a mode allowing the locking part to be unlocked from the rear link or the front link.

In a further embodiment, upon receiving information on a position of the switching guide part and determining that the switching guide part is spaced apart from the slide guide, the controller may be configured to enable operation of a relaxation mode.

In another further embodiment, the relaxation mode may be a mode allowing the rear link to be rotated rearwards so as to move the seat cushion part to a relaxation position in a state in which the locking part is in a locked position to prevent forward rotation of each of the rear link and the front link.

In another embodiment, a locking device for a vehicle walk-in seat comprises: a seat cushion part mounted on a movement rail of a seat rail and configured to slide along the seat rail; a rear link that includes a first link mounted on a first side of a rear portion of the seat cushion part, and a second link mounted on a second side of the rear portion of the seat cushion part; a front link that includes a third link mounted on a first side of a front portion of the seat cushion part, and a fourth link mounted on a second side of the front portion of the seat cushion part; a locking part configured to engage with at least one of the first link, the second link, the third link, or the fourth link; and a switching guide part mounted on the seat cushion part. In particular, the switching guide part is configured to be seated on a slide guide provided in a fixed rail of the seat rail and to move such that the locking part is released from engagement with the rear link or the front link.

Other aspects and embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure are now described in detail with reference to certain exemplary embodiments thereof illustrated in the accompanying drawings which are given hereinbelow by way of illustration only, and thus are not limitative of the present disclosure, and wherein:

FIG. 1 is a diagram showing a locking device of a vehicle walk-in seat according to an embodiment of the present disclosure;

FIG. 2 is a diagram showing a link structure of the locking device of the vehicle walk-in seat according to an embodiment of the present disclosure;

FIG. 3 is a diagram showing a walk-in tilting mode of the locking device of the vehicle walk-in seat according to an embodiment of the present disclosure;

FIG. 4 is a diagram showing a relaxation mode of the locking device of the vehicle walk-in seat according to an embodiment of the present disclosure;

FIG. 5 is a diagram showing a first locking part of the locking device of the vehicle walk-in seat according to an embodiment of the present disclosure;

FIG. 6 is a diagram showing a second locking part of the locking device of the vehicle walk-in seat according to an embodiment of the present disclosure;

FIG. 7 is a diagram showing a switching guide part of the locking device of the vehicle walk-in seat according to an embodiment of the present disclosure;

FIGS. 8A and 8B are diagrams each showing a state in which a front link is locked in the locking device of the vehicle walk-in seat according to an embodiment of the present disclosure;

FIGS. 9A and 9B are diagrams each showing a state in which a rear link is locked in the locking device of the vehicle walk-in seat according to an embodiment of the present disclosure;

FIGS. 10A and 10B are diagrams each showing a state in which the front link is unlocked in the locking device of the vehicle walk-in seat according to an embodiment of the present disclosure;

FIGS. 11A and 11B are diagrams each showing a state in which the rear link is unlocked in the locking device of the vehicle walk-in seat according to an embodiment of the present disclosure;

FIG. 12 is a diagram showing a configuration of the locking device of the vehicle walk-in seat according to an embodiment of the present disclosure; and

FIG. 13 is a diagram showing the start time of the walk-in tilting mode of the vehicle walk-in seat according to an embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below.

Advantages and features of the present disclosure and a method of achieving the same should become more apparent with reference to the embodiments described below in detail and the accompanying drawings.

However, the present disclosure is not limited by the embodiments disclosed below, and may be implemented in various forms. The embodiments are provided to ensure that the disclosure of the present disclosure is complete, and to fully inform the scope of the disclosure to those skilled in the art to which the present disclosure pertains, and the present disclosure is only defined by the scope of the claims.

In describing the embodiments disclosed herein, when it is determined that a detailed description of publicly known techniques to which the disclosure pertains may obscure the gist of the present disclosure, the detailed description thereof has been omitted.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

In the present disclosure, each of phrases such as “A or B”, “at least one of A or B”, “at least one of A, B or C” and “at least one of A, B, or C, or a combination thereof” may include any one or all possible combinations of the items listed together in the corresponding one of the phrases.

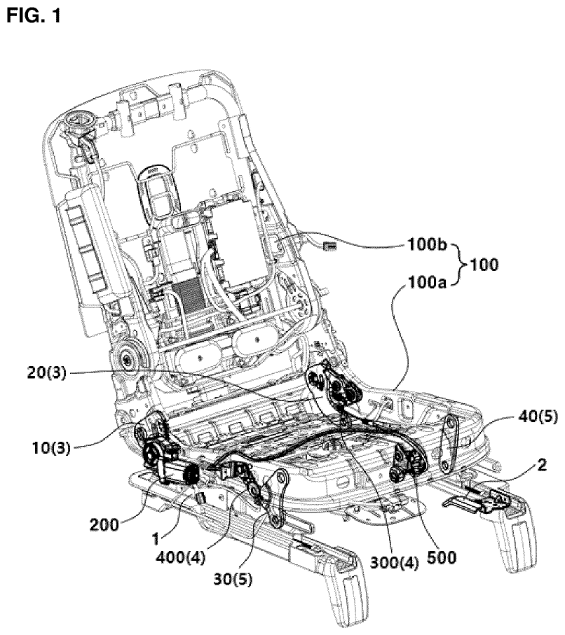

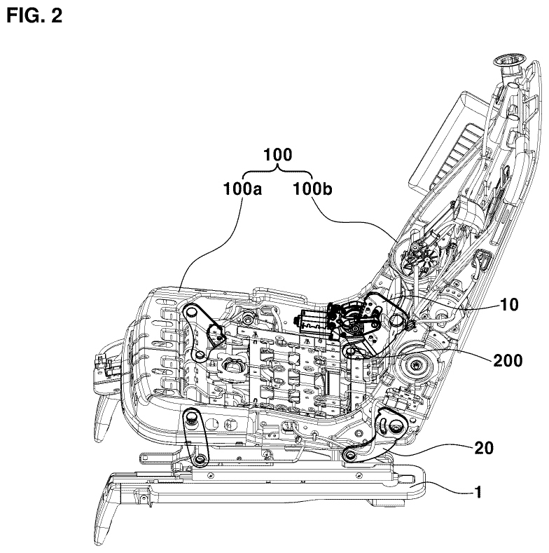

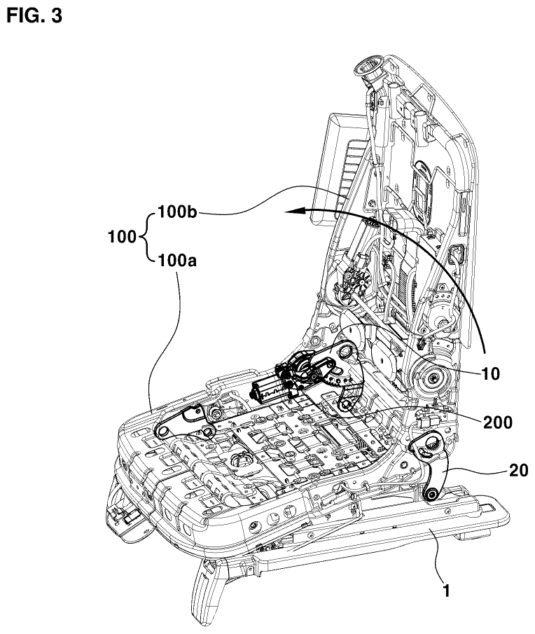

FIG. 1 is a diagram showing a locking device of a vehicle walk-in seat according to an embodiment of the present disclosure, FIG. 2 is a diagram showing a link structure of the locking device of the vehicle walk-in seat according to the embodiment of the present disclosure, and FIG. 3 is a diagram showing a walk-in tilting mode of the locking device of the vehicle walk-in seat according to the embodiment of the present disclosure.

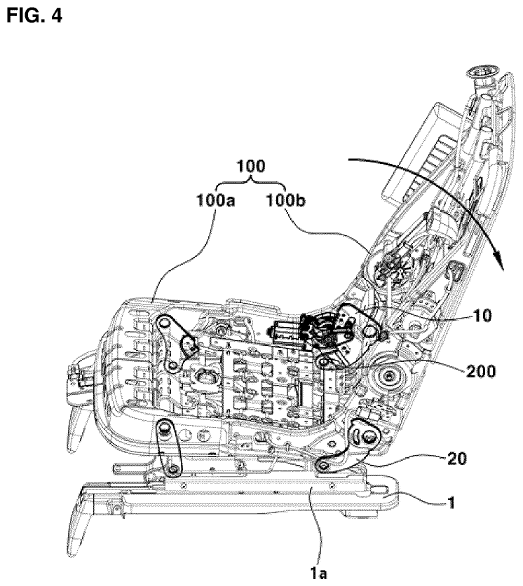

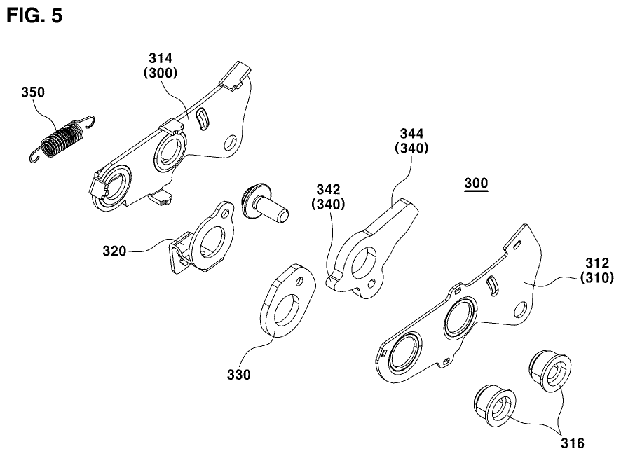

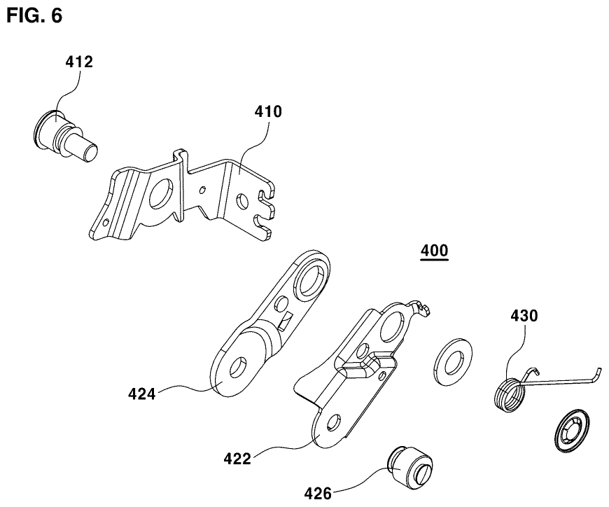

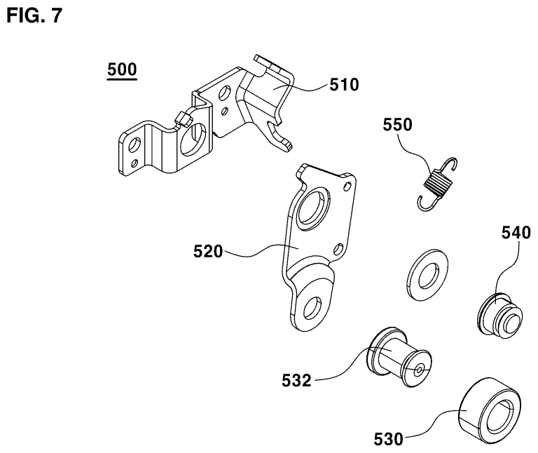

FIG. 4 is a diagram showing a relaxation mode of the locking device of the vehicle walk-in seat according to the embodiment of the present disclosure, FIG. 5 is a diagram showing a first locking part of the locking device of the vehicle walk-in seat according to the embodiment of the present disclosure, FIG. 6 is a diagram showing a second locking part of the locking device of the vehicle walk-in seat according to the embodiment of the present disclosure, and FIG. 7 is a diagram showing a switching guide part of the locking device of the vehicle walk-in seat according to the embodiment of the present disclosure.

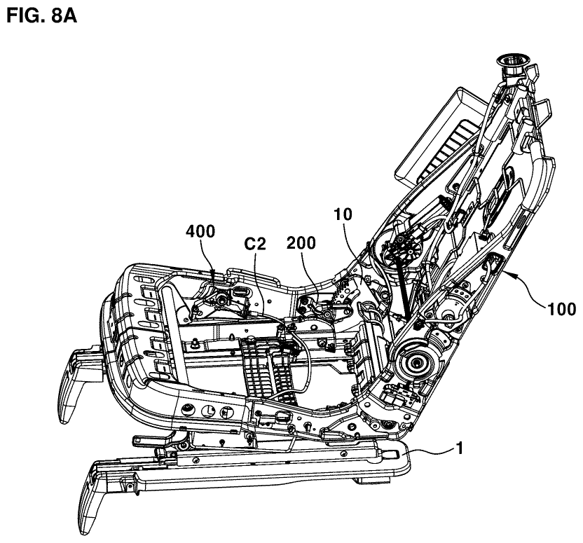

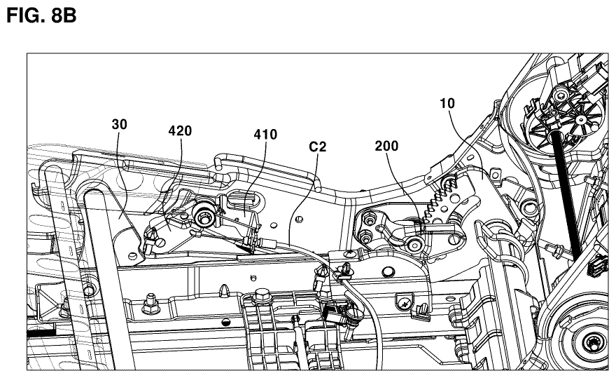

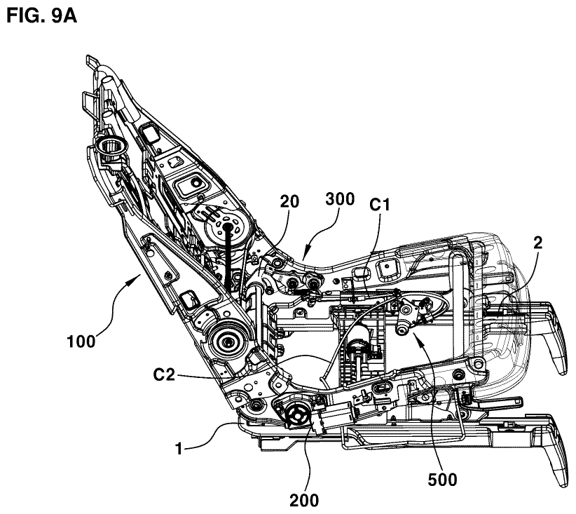

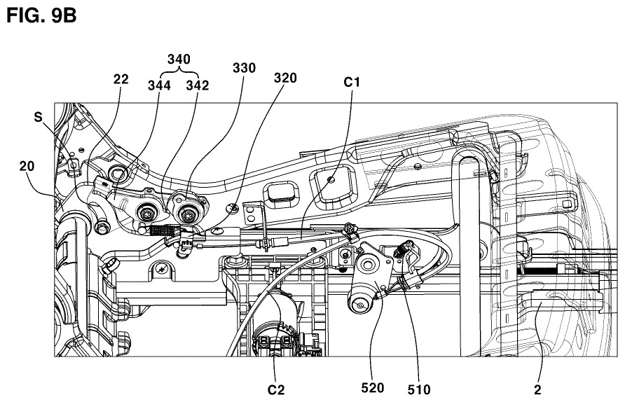

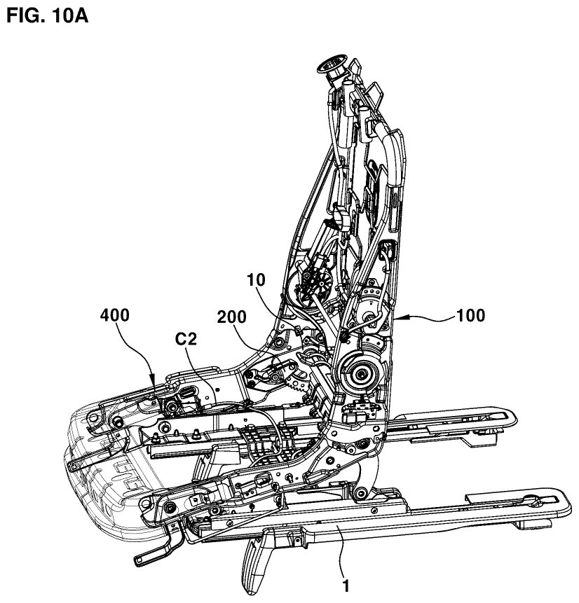

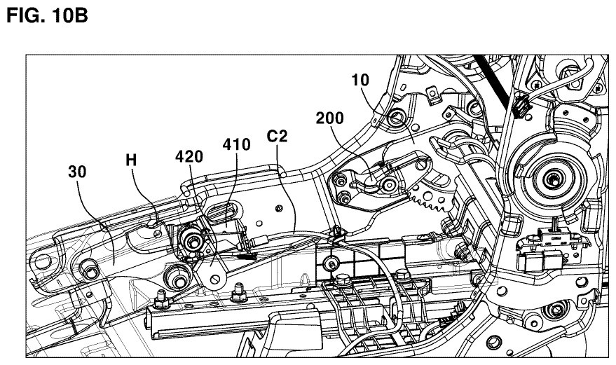

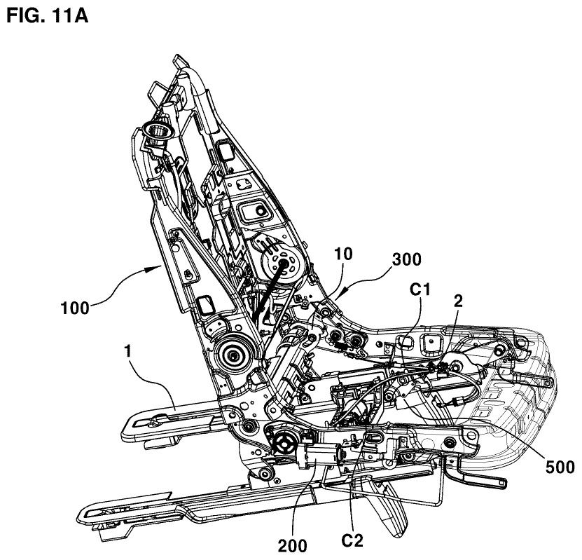

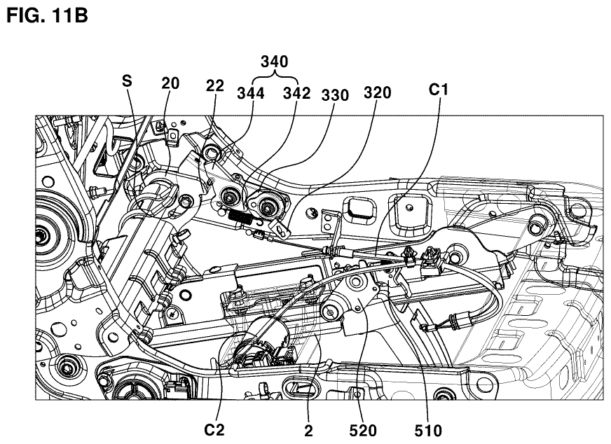

FIGS. 8A and 8B are diagrams each showing a state in which a front link is locked in the locking device of the vehicle walk-in seat according to the embodiment of the present inventio, FIGS. 9A and 9B are diagrams each showing a state in which a rear link is locked in the locking device of the vehicle walk-in seat according to the embodiment of the present disclosure, FIGS. 10A and 10B are diagrams each showing a state in which the front link is unlocked in the locking device of the vehicle walk-in seat according to the embodiment of the present disclosure, and FIGS. 11A and 11B are diagrams each showing a state in which the rear link is unlocked in the locking device of the vehicle walk-in seat according to the embodiment of the present disclosure.

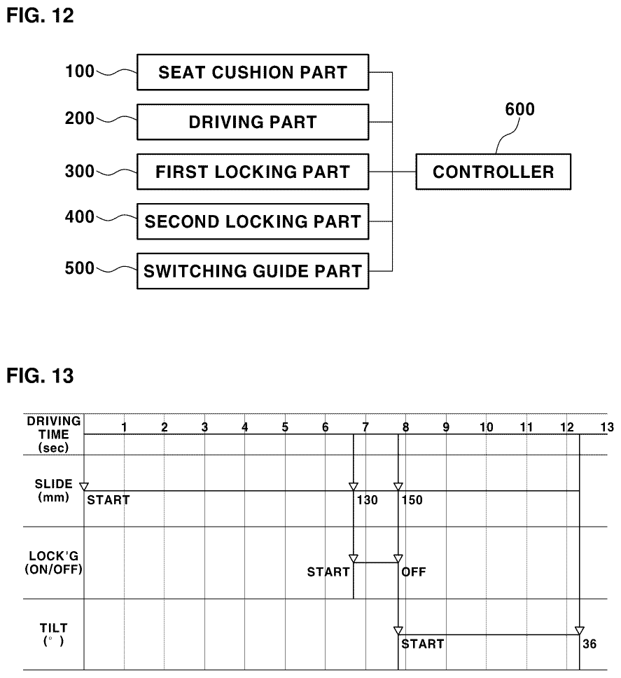

FIG. 12 is a diagram showing a configuration of the locking device of the vehicle walk-in seat according to the embodiment of the present disclosure, and FIG. 13 is a diagram showing the start time of the walk-in tilting mode of the vehicle walk-in seat according to the embodiment of the present disclosure.

According to an embodiment of the present disclosure, as illustrated in FIG. 1, a locking device of a vehicle walk-in seat may include a seat cushion part 100, a rear link 3 having a first link 10 and a second link 20, a locking part 4 having a first locking part 300 and a second locking part 400, a front link 5 having a third link 30 and a fourth link 40, and a switching guide part 500.

The seat cushion part 100 is configured to be slidably moved forward and rearward along a seat rail 1 that is formed to extend in the forward-and-rearward direction of the vehicle.

The seat cushion part 100 includes a seat cushion 100a and a seatback 100b rotatably coupled to the seat cushion 100a for angle adjustment thereof in the forward-and-rearward direction.

The seat cushion part 100 may have a driving part 200 provided on one side of the rear side thereof, i.e., one of both sides at which the seat cushion 100a and the seatback 100b are coupled to each other.

The driving part 200 is not applied to the manual seat cushion part 100. The driving part 200 may be selectively applied only to the electric seat cushion part 100. As shown in FIG. 2, the driving part 200 may be coupled to the first link 10 so as to deliver driving force to the first link 10, such that the seatback 100b is rotated forward or rearward relative to the seat cushion 100a.

The driving part 200 may include a driving motor. For example, as shown in FIG. 4, in a state in which a first locking part 300 is located to be locked (i.e., engaged) with the second link 20 having one side mounted on the rear portion of the seat cushion part 100 and the other side mounted on the rear part of a movement rail 1a of the seat rail 1, and the second locking part 400 is located to be locked (i.e., engaged) with the third link 30. The third link 30 includes a part (e.g., a first part) mounted on the front portion of the seat cushion part 100, and another part (e.g., a second part) mounted on the front part of the movement rail 1a of the seat rail 1. When the seat mode is switched to the relaxation mode, the rear portion of the seat cushion 100a is moved downward, and the front portion of the seat cushion 100a is moved upward, thereby implementing a relaxation posture of the seat cushion part 100.

Here, the relaxation mode may be set to a mode in which the second link 20 is rotated rearward so as to switch to the relaxation position of the seat cushion part 100 in a state in which the first locking part 300 and the second locking part 400 are respectively located to be locked (i.e., engaged) with the second link 20 and the third link 30 so as to prevent forward rotation of the second link 20 and the third link 30.

Here, in the relaxation mode, both the first locking part 300 and the second locking part 400 may be respectively located to be locked with the second link 20 and the third link 30 so as to prevent forward rotation of the second link 20 and the third link 30, but this configuration is only one embodiment, and the present disclosure is not limited thereto. For example, the relaxation mode may be implemented when at least one of the first locking part 300 and the second locking part 400 is located to be locked with a corresponding one of the second link 20 and the third link 30 so as to prevent forward rotation of the second link 20 or the third link 30.

The driving part 200 is usually mounted on one side of the seat cushion part 100. When the driving part 200 is mounted on one side as described above, strength of the seat may be reduced, which may cause marketability deterioration due to malfunctioning of the driving part.

As illustrated in FIG. 1, the first locking part 300 is mounted on the other side of the rear portion of the seat cushion part 100 so as to face the driving part 200 and is configured to be locked (i.e., engaged) with the second link 20 facing the first link 10.

As shown in FIG. 3, in the walk-in tilting mode, the second link 20 may stand upright by axial rotation thereof when the second link 20 is unlocked (i.e., disengaged) from the first locking part 300. Further, the seat cushion part 100 may be rotated forwards by the driving part 200, thereby implementing a tilting function of the seat cushion part 100.

The first locking part 300 may include a mounting plate 310, a release lever 320, a cam member 330, and a locking plate 340, as shown in FIG. 5.

The mounting plate 310 is fixedly mounted on the rear portion of the seat cushion part 100.

This mounting plate 310 may be configured to have a structure in which a first cover bracket 312 located on the inside of the mounting plate and a second cover bracket 314 located on the outside thereof are coupled to each other through a pair of rivet members 316.

The release lever 320 is rotatably coupled to the inner side of the mounting plate 310, and as shown in FIGS. 9A and 9B, the protruding side of the release lever is formed to be connected to a first cable C1 of the switching guide part 500.

In addition, the cam member 330 is coupled to the release lever 320 and is formed to be rotated with the release lever 320. Here, the cam member may include one side protruding toward the locking plate 340.

In an embodiment, the locking plate 340 may have a protruding member 342 configured to selectively engage with the protruding side of the cam member 330. The locking plate 340 is rotated according to the rotation of the cam member 330 that is rotated by rotation of the release lever 320. In this manner, the locking plate is disengaged (i.e., unlocked) from the second link 20.

In an embodiment, the locking plate 340 includes a locking guide member 344 that extends in the longitudinal direction so as to be locked with a locking piece 22 of the second link 20.

The first locking part 300 may further include an elastic member 350, and the elastic member 350 is mounted on the second cover bracket 314 of the mounting plate 310 and is connected to the release lever 320. Further, the elastic member provides elastic restoring force to the release lever 320 that is configured to be selectively rotatable.

In an embodiment, as illustrated in FIG. 1, the second locking part 400 is mounted on one side of the front portion of the seat cushion part 100 and is locked with the third link 30 provided in front of the first link 10 (refer to FIG. 1).

As shown in FIG. 6, the second locking part 400 may include a mounting plate 410 and a locking bracket 420.

The mounting plate 410 is fixedly mounted on the front portion of the seat cushion part 100. The locking bracket 420 is coupled to the mounting plate 410 and is rotatable around a rotation shaft 412. Further, the locking bracket is connected to a second cable C2 of the switching guide part 500, as shown in FIGS. 8A and 8B.

The locking bracket 420 may be formed by coupling a first cover member 422 and a second cover member 424 to each other and may include a locking pin 426 formed to have a shape corresponding to the shape of a locking groove H formed in the third link 30 (refer to FIG. 10B).

The locking bracket 420 is configured in such a manner that the locking pin 426 is unlocked from the locking groove H of the third link 30 when the locking bracket 420 is rotated rearward from the mounting plate 410 by pulling the second cable C2 of the switching guide part 500.

In addition, the second locking part 400 may further include an elastic member 430. The elastic member 430 is mounted on the mounting plate 410 and is connected to the locking bracket 420 so as to provide elastic restoring force to the selectively rotatable locking bracket 420.

In an embodiment, the switching guide part 500 is mounted on the seat cushion part 100. For example, the switching guide part 500 may be mounted on the lower portion of the seat cushion part 100. Further, the switching guide part is configured to allow the first locking part 300 and the second locking part 400 to be respectively unlocked from the second link 20 and the third link 30 while moving in a state of being seated on the slide guide 2 provided on the front side of the seat rail 1.

The switching guide part 500 may include a mounting plate 510, an unlocking lever 520, and a roller member 530, as shown in FIG. 7.

The mounting plate 510 is fixedly mounted on the lower portion of the seat cushion part 100 (refer to FIG. 1).

As shown in FIGS. 11A and 11B, the unlocking lever 520 is located to come into contact with the slide guide 2 and is configured to rotate around a rivet lever 540 on the mounting plate 510.

Here, the unlocking lever 520 includes the first cable C1 that extends to the other side of the rear portion of the seat cushion part 100 and is connected to the first locking part 300, more specifically, the release lever 320, and the second cable C2 that extends to one side of the front portion of the seat cushion part 100 and is connected to the second locking part 400, more specifically, the locking bracket 420.

When the unlocking lever 520 is moved in a state of contacting the slide guide 2, the unlocking lever is pressed by one inclined side of the slide guide 2 and is rotated on the mounting plate 510, thereby simultaneously moving the first cable C1 and the second cable C2 in a direction in which the first cable C1 and the second cable C2 are pulled. In this manner, the first locking part 300 and the second locking part 400 are unlocked from the second link 20 and the third link 30, respectively.

The roller member 530 is coupled to the unlocking lever 520 through a shaft lever 532 and guides the unlocking lever 520 to move along the slide guide 2 by rolling operation thereof in a state of being in contact with the slide guide 2. In other words, the roller member 530 facilitates the movement of the unlocking lever 520 along the slide guide 2 by rolling while maintaining contact with the slide guide 2.

In addition, the switching guide part 500 may further include an elastic member 550. The elastic member 550 is mounted on the mounting plate 510 and is connected to the unlocking lever 520. Further, the elastic member provides elastic restoring force to the selectively rotatable unlocking lever 520.

Hereinafter, the operation of the walk-in tilting mode will be described based on the configuration of the locking device of the vehicle walk-in seat (refer to FIGS. 1 to 7).

In a state in which the seat cushion part 100 is slidably movable forwards and rearwards (refer to FIG. 2), for example, in a state in which a relaxation mode is implemented by the driving part 200 (refer to FIG. 4), as shown in FIGS. 9A and 9B, the locking guide member 344 is fixed in a state of being locked with the locking piece 22 of the second link 20.

Similarly, the seat cushion part 100 is slidably movable forwards and rearwards (refer to FIG. 2). For example, in a state in which implementation of the relaxation mode is possible through the driving part 200 (refer to FIG. 4), as shown in FIGS. 8A and 8B, the locking pin 426 of the locking bracket 420 is fixed in a state of being locked in the locking groove H of the third link 30.

In this case, the seat cushion part 100 is slidably moved forwards, and as shown in FIG. 11A and FIG. 11B, when the unlocking lever 520 is moved in a state of facing the slide guide 2, the unlocking lever 520 is rotated while being pressed by the inclined surface of one side of the slide guide 2. Here, the inclined surface is formed to inclined upwards.

As described above, when the unlocking lever 520 is rotated by the inclined surface of the slide guide 2, the first cable C1 is moved in a direction in which the first cable is pulled. Here, when the first cable C1 is pulled, the release lever 320 is rotated.

Through this structural configuration, the cam member 330 configured to be rotated in conjunction with the release lever 320 presses the protruding member 342, and the locking plate 340 is continuously rotated in a direction opposite to the rotation direction of the cam member 330. As a result, the locking guide member 344 is disengaged or unlocked from the locking piece 22 of the second link 20 (refer to FIGS. 11A and 11B), and the second link 20 is released from the engagement (i.e., unlocked) with the locking plate 340.

When the unlocking lever 520 is further moved in the longitudinal direction of the slide guide 2, the second link 20 is elastically rotated along a slot “S” to stand upright in a state in which the locking plate 340 is unlocked from the second link 20. Accordingly, as shown in FIG. 3, the walk-in tilting mode is entered.

Additionally, as shown in FIG. 10A and FIG. 10B, when the unlocking lever 520 is rotated, the first cable C1 and the second cable C2 are simultaneously pulled. Accordingly, the locking bracket 420 connected to the second cable C2 is also rotated in the direction in which the second cable C2 is pulled.

In this manner, when the locking bracket 420 is rotated by the second cable C2, the locking pin 426 is separated from the locking groove H of the third link 30, thereby allowing the locking bracket to be unlocked from the third link 30.

Here, when the unlocking lever 520 is further moved in the longitudinal direction of the slide guide 2, the first link 10 is rotated by the driving part 200, while the second link 20 and the fourth link 40 maintain the upright posture. This occurs in a state where the locking plate 340 and the locking bracket 420 are respectively disengaged (i.e., unlocked) from the second link 20 and the third link 30. Further, as shown in FIG. 3, the seat cushion part 100 is switched to the walk-in tilting mode in which the seatback is tilted forwards.

According to an embodiment of the present embodiment, as illustrated in FIG. 12, the locking device of the vehicle walk-in seat may further include a controller 600 configured to, in response to receiving a walk-in tilting control command, cause the seat cushion part 100 to move forward and cause the switching guide part 500 to move along the slide guide 2 so as to start the walk-in tilting mode.

Here, when a control command for the walk-in tilting mode, such as operation of a separate user button (not shown), is executed, the controller 600 causes the seat cushion part 100 to move forward from its current position initiate the walk-in tilting mode. In other words, the seat cushion part is controlled to move toward a predetermined non-seating section, which is set further forward than a seating section where passenger seating movement occurs along a slide movement path of the seat cushion part. Additionally, the first locking part 300 and the second locking part 400 are controlled to be disengaged (i.e., unlocked) from the second link 20 and the third link 30, respectively.

In this case, as shown in FIG. 13, when it is determined that the seat cushion part 100 has reached a position, for example, 130 mm forward from the rearmost position of the seat rail 1, which includes the seating section, relative to the non-seating section, the controller 600 further moves the seat cushion part 100 to a position, for example, 150 mm, in response to user operation. This movement causes the first locking part 300 and the second locking part 400 to be disengaged or unlocked from the second link 20 and the third link 30, respectively. This disengaged or unlocked state is maintained until the seat cushion part 100 reaches a preset angle, for example, 36 degrees.

In other words, when the controller 600 moves the seat cushion part 100 such that the seat cushion part reaches a point of 150 mm, the unlocking lever 520 comes into contact with the inclined side of the slide guide 2 and is rotated. Accordingly, while the first cable C1 and the second cable C2 are pulled, the release lever 320 and the locking bracket 420 are rotated, and the first locking part 300 and the second locking part 400 are unlocked from the second link 20 and the third link 30, respectively.

In addition, the controller 600 receives position information according to slide movement of the seat cushion part 100. Here, upon determining that the switching guide part 500 is located to be spaced apart from the slide guide 2 by a predetermined distance, i.e., upon determining that the switching guide part is located in the seating section set on the slide movement path of the seat cushion part 100, the controller 600 may control the driving part 200 to selectively implement the relaxation mode.

The present disclosure applies a locking system applied configured to lock the seat in a predetermined seating section and selectively release locking of the seat when the seat moves from the predetermined seating section to a predetermined non-seating section, i.e., when the seat is slidably moved forward. This configuration enables a walk-in tilting mode by unlocking the seat through the seat's sliding movement.

In addition, the present disclosure has an effect of improving the structural integrity of the seat by installing a locking system at a position facing a motor that is mounted on one side of the seat so as to perform the walk-in tilting mode and the relaxation mode (the seatback is rotated rearward), thereby improving marketability.

As is apparent from the above description, the present disclosure provides a locking device for a vehicle walk-in seat, having a locking system applied thereto and configured to lock the seat in a predetermined seating section and selectively release locking of the seat when the seat is moved from the predetermined seating section to a predetermined non-seating section, i. e, when the seat is slidably moved forward, thereby having an effect of implementing a walk-in tilting mode by unlocking the seat through the seat's sliding movement.

A locking system is installed at a position facing a motor that is mounted on one side of the seat so as to perform the walk-in tilting mode and the relaxation mode (the seatback is rotated rearwards), thereby having an effect of improving the structural integrity of the seat and improving marketability.

The present disclosure has been described in detail with reference to embodiments shown in the drawings, but the embodiments are merely illustrative. It will be appreciated by those having ordinary skill in the art that various modifications may be made from the embodiments, and all or a part of the embodiments may be selectively combined with each other. Therefore, the true technical protection scope of the present disclosure should be defined by the technical spirit of the appended claims.

What is claimed is:

1. A locking device for a vehicle walk-in seat, the locking device comprising:
a seat cushion part mounted on a movement rail of a seat rail, the seat cushion part configured to slide along the seat rail;
a rear link including:
a first part mounted on a rear portion of the seat cushion part, and
a second part mounted on a rear part of the movement rail of the seat rail;
a front link including:
a first part mounted on a front portion of the seat cushion part, and
a second part mounted on a front part of the movement rail of the seat rail;
a locking part configured to engage with the rear link or the front link; and
a switching guide part mounted on the seat cushion part and configured to be seated on a slide guide provided in a fixed rail of the seat rail and to move such that the locking part is released from engagement with the rear link or the front link.

2. The locking device of claim 1, wherein:
the rear link comprises:
a first link mounted on a first side of the rear portion of the seat cushion part; and
a second link mounted on a second side of the rear portion of the seat cushion part,
the front link comprises:
a third link mounted on a first side of the front portion of the seat cushion part; and
a fourth link mounted on a second side of the front portion of the seat cushion part, and
the locking part is configured to engage with at least one of the first link, the second link, the third link, or the fourth link.

3. The locking device of claim 2, further comprising:
a driving part mounted on the seat cushion part and coupled to the first link, the driving part configured to apply a driving force to the first link to rotate the seat cushion part forward or rearward.

4. The locking device of claim 3, wherein when the locking part is disengaged, the seat cushion part is rotatably tilted in conjunction with driving of the driving part.

5. The locking device of claim 2, wherein the locking part comprises:
a first locking part mounted on the rear portion of the seat cushion part and configured to engage with the second link facing the first link; and
a second locking part mounted on the front portion of the seat cushion part and configured to engage with the third link located in front of the first link.

6. The locking device of claim 5, wherein the first locking part comprises:
a mounting plate fixedly mounted on the rear portion of the seat cushion part;
a release lever rotatably coupled to the mounting plate and connected to the switching guide part;
a cam member configured to rotate with the release lever;
a locking plate including a protruding member configured to engage the cam member, the locking plate being rotatable in conjunction with rotation of the cam member and configured to selectively disengage from the rear link; and
an elastic member mounted on the mounting plate and connected to the release lever, the elastic member configured to provide an elastic restoring force to the release lever.

7. The locking device of claim 6, wherein:
the locking plate includes a locking guide member configured to engage with a locking piece of the rear link, and
the locking plate is configured to rotate in a direction opposite to a rotation direction of the cam member so as to disengage from the locking piece.

8. The locking device of claim 5, wherein the second locking part comprises:
a mounting plate fixedly mounted on the front portion of the seat cushion part; and
a locking bracket connected to the switching guide part and configured to be rotatably coupled to the mounting plate.

9. The locking device of claim 8, wherein:
the locking bracket comprises a locking pin mounted in the mounting plate and formed to have a shape corresponding to a shape of a locking groove formed in the front link, and
the locking pin is disengaged from the locking groove when the locking bracket is rotated rearward on the mounting plate by the switching guide part.

10. The locking device of claim 8, wherein the second locking part further comprises an elastic member mounted on the mounting plate and connected to the locking bracket, the elastic member configured to provide an elastic restoring force to the locking bracket.

11. The locking device of claim 1, wherein the switching guide part comprises:
a mounting plate fixedly mounted on a lower portion of the seat cushion part;
an unlocking lever configured to rotate on the mounting plate when the slide guide contacts the unlocking lever connected to the locking part;
a roller member coupled to the unlocking lever and configured to guide the unlocking lever to move along the slide guide; and
an elastic member mounted on the mounting plate and connected to the unlocking lever, the elastic member configured to apply an elastic restoring force to the unlocking lever.

12. The locking device of claim 11, wherein:
the rear link comprises:
a first link mounted on a first side of the rear portion of the seat cushion part; and
a second link mounted on a second side of the rear portion of the seat cushion part,
the front link comprises:
a third link mounted on a first side of the front portion of the seat cushion part; and
a fourth link mounted on a second side of the front portion of the seat cushion part,
the locking part comprises:
a first locking part mounted on the second side of the rear portion of the seat cushion part and configured to engage with the second link facing the first link; and
a second locking part mounted on the first side of the front portion of the seat cushion part and configured to engage with the third link located in front of the first link, and
the unlocking lever comprises:
a first cable connected to the first locking part; and
a second cable connected to the second locking part.

13. The locking device of claim 12, wherein the unlocking lever simultaneously moves the first cable and the second cable by rotation thereof on the mounting plate, thereby allowing the first locking part and the second locking part to be respectively disengaged from the rear link and the front link.

14. The locking device of claim 1, wherein the slide guide includes a side inclined upward so as to allow the switching guide part to be rotatably moved.

15. The locking device of claim 1, wherein the slide guide is provided at a position allowing the slide guide to contact the switching guide part in a non-seating section set on a slide movement path of the seat cushion part.

16. The locking device of claim 1, further comprising a controller configured to, in response to receiving a walk-in tilting control command, move the seat cushion part forward and move the switching guide part along the slide guide to initiate a walk-in tilting mode.

17. The locking device of claim 16, wherein the walk-in tilting mode is a mode allowing the locking part to be disengaged from the rear link or the front link.

18. The locking device of claim 16, wherein, upon receiving information on a position of the switching guide part and determining that the switching guide part is spaced apart from the slide guide, the controller is configured to enable operation of a relaxation mode.

19. The locking device of claim 18, wherein the relaxation mode is a mode allowing the rear link to be rotated rearward so as to move the seat cushion part to a relaxation position in a state in which the locking part is in a locked position to prevent forward rotation of each of the rear link and the front link.

20. A locking device for a vehicle walk-in seat, the locking device comprising:
a seat cushion part mounted on a movement rail of a seat rail and configured to slide along the seat rail;
a rear link including:
a first link mounted on a first side of a rear portion of the seat cushion part, and
a second link mounted on a second side of the rear portion of the seat cushion part;
a front link including:
a third link mounted on a first side of a front portion of the seat cushion part, and
a fourth link mounted on a second side of the front portion of the seat cushion part;
a locking part configured to engage with at least one of the first link, the second link, the third link, or the fourth link; and
a switching guide part mounted on the seat cushion part,
wherein the switching guide part is configured to be seated on a slide guide provided in a fixed rail of the seat rail and to move such that the locking part is released from engagement with the rear link or the front link.
